(19) United States
(12) Patent Application Publication
(10) Pub. No.: US 2026/0253138 A1
(43) Pub. Date: Aug. 27, 2026

(54) METHODS AND APPARATUSES FOR GENERATING A NEW CREDIT FILE AND ADDING TRADELINES

(71) Applicant: ConsumerInfo.com, Inc., Costa Mesa, CA (US)

(72) Inventors: John Haviland Cornell, III, Laguna Beach, CA (US); Aaron Jordan Kline, San Diego, CA (US); Jazmin Adriana Quezada, Santa Ana, CA (US); Lucy Okamuro, Costa Mesa, CA (US); Christopher Brian Orchid, Irvine, CA (US); Debbie Hsu, Irvine, CA (US); Michelle Felice-Steele, Woodland Hills, CA (US); Matt Nobar, Irvine, CA (US)

(21) Appl. No.: 19/549,372

(22) Filed: Feb. 25, 2026

Related U.S. Application Data
(63) Continuation of application No. 18/051,846, filed on Nov. 1, 2022, now Pat. No. 12,586,126.
(60) Provisional application No. 63/263,499, filed on Nov. 3, 2021.
(60) Provisional application No. 63/302,479, filed on Jan. 24, 2022.

(51) Int. Cl. G06Q 40/03

(52) U.S. Cl. CPC G06Q 40/03

(57) ABSTRACT

The present disclosure describes systems and methods for providing new credit files for individuals without a credit file by generating header information and assigning a personal identifier (or PIN) for the newly created header file without any negative impacts on the new credit file (such as a credit inquiry). The credit system can recommend the addition of new tradelines, such as through review of transaction data from financial institutions to identify a new tradeline, or recommending new credit cards curated for individuals with new credit files. The credit system can infer an open date for a new tradeline found in the transaction data by identifying the earliest transaction date for the set of transactions that correspond to a particular category.

### CROSS-REFERENCE TO RELATED APPLICATIONS

Any and all applications for which a foreign or domestic priority claim is identified in the Application Data Sheet as filed with the present application are incorporated by reference under 37 CFR 1.57 and made a part of this specification. This application claims priority to U.S. patent application Ser. No. 18/051846, filed on Nov. 1, 2022, which claims priority to U.S. Prov. App. No. 63/263499, filed on Nov. 3, 2021 and U.S. Prov. App. No. 63/302479, filed Jan. 24, 2022, which are hereby incorporated by reference in their entirety.

### BACKGROUND

Credit database technologies have provided consumers with a credit file that can be accessed by third party merchants to verify the creditworthiness of the consumers. However, individuals without a credit file have a difficult time establishing such a credit file using traditional credit database technologies. Traditional credit database technologies do not have features enabling individuals to start a new credit file directly with the credit bureau. New credit files are typically created based on a new account opening or an inquiry by a third-party lender, creditor or other account provider. For example, these credit files may be initially established in response to an inquiry by a third party requesting a credit file for an individual that desires to establish a credit account or loan, and a credit file is generated for the individual that includes the inquiry (e.g., such as a hard inquiry) that negatively affects the credit worthiness of the individual.

### SUMMARY

The present disclosure describes systems and methods for providing credit files to consumers without credit files and/or to help consumers become scorable (e.g., have a credit file with sufficient information that it can be used to generate a credit score) when their credit file is without a tradeline or if their credit file does not have sufficient history of credit. Aspects of the present disclosure relate to improved systems and methods for causing a record of an individual to be generated and stored in a regulated credit database of a credit bureau, which may be initiated directly by the individual without applying for a loan, credit or other third party account which could negatively affect the credit worthiness of the individual.

In existing credit file creation data flows, new credit files are typically generated based in part on real life in-person inquiries at a third-party's location, such as a financial institution, lender or creditor with which the person is establishing or attempting to establish an account. In these cases, a human (such as an employee of a bank or merchant) typically receives a physical copy of a government issued identity document (“ID”) and confirms that the government issued ID matches the person sitting in front of them. Traditional credit file database technologies do not include automated ID verification of an image or video stream captured by a user's device or comparing such an image or video with a government issued ID for the purposes of generating a new credit file.

Aspects of the present disclosure enable an individual to move from having no credit file to having a credit file without taking on debt, as well as going from having no credit score to becoming scorable by a credit scoring algorithm potentially in minutes without taking on debt. The user can go from having no credit file to becoming scorable all within the same browsing session.

Some embodiments include a computer-implemented method comprising: receiving Personal Identifiable Information (“PII”) and a digital image of an identification document (“ID”) from a computing device of a user, wherein the PII includes a name and an address of the user; determining that ID information extracted from the digital image of the ID corresponds to the PII provided by the user; determining that the PII does not correspond to any credit files in a credit file database; confirming that the ID belongs to the user based at least in part on analysis of a picture of the user captured by a camera of the computing device; generating a personal identifier and a credit file for the user; accessing transaction data of the user via an API communication channel established with one or more databases associated with a third-party entity storing the transaction data; identifying a new tradeline from a set of transactions within the transaction data that collectively relate to a tradeline category; and initiating addition of the new tradeline to the credit file of the user, wherein the new tradeline identifies the tradeline category.

In some embodiments, the digital image is captured by the camera of the computing device.

In some embodiments, the ID is a passport, a driver license, or a government issued ID of the user.

In some embodiments, the method further comprises recommending one or more data items to the user for which the user was not eligible prior to the generation of the credit file.

In some embodiments, the one or more data items comprise a feature to provide additional information related to improving the user's credit file.

In some embodiments, the one or more data items comprise a feature to monitor the credit file.

In some embodiments, the method further comprises providing the personal identifier to a third party for identity verification of the user by the third-party.

In some embodiments, the method further comprises verifying that the name and a social security number provided by the user via the computing device matches a name and social security number in at least one of the databases, wherein the at least one of the databases includes a government database.

Some embodiments include a system comprising: memory; and
one or more hardware processors configured to: receive Personal Identifiable Information (“PII”) and a digital image of an identification document (“ID”) from a computing device of a user, wherein the PII includes a name and an address of the user; determine that ID information extracted from the digital image of the ID corresponds to the PII provided by the user; determine that the PII does not correspond to any credit files in a credit file database; confirm that the ID belongs to the user based at least in part on analysis of a picture of the user captured by a camera of the computing device; generate a personal identifier and a credit file for the user; and recommend one or more data items to the user for which the user was not eligible prior to the generation of the credit file.

In some embodiments, a credit score of the user was not available prior to the generation of the credit file.

In some embodiments, the credit file, upon generation of the credit file, includes does include data that only impacts the credit file negatively, wherein the data does not include a credit inquiry.

In some embodiments, the one or more hardware processors are further configured to: receive authorization to access transactions by the user from a financial institution account of a financial institution; access the transactions in the financial institution account; infer an account between a third-party entity and the user by applying an account identification rule to the transactions; and add the inferred account to the credit file of the user.

In some embodiments, the one or more hardware processors are further configured to determine whether the PII meets one or more threshold minimum requirements for generating the credit file for the user.

In some embodiments, the one or more hardware processors are further configured to determine that the name and the address of the user correspond to a name and address of one or more user profiles in one or more third-party databases.

In some embodiments, the personal identifier is specific to the credit file for the user, is not included in the ID information, and is not included in the PII provided by the user.

In some embodiments, the one or more data items comprise a feature to add accounts to the credit file of the user.

In some embodiments, the one or more hardware processors are further configured to: receive a selection of the feature to add accounts to the credit file of the user; add one or more accounts to the credit file of the user; generate a credit score of the user based on the credit file that includes the added one or more accounts; and provide the credit score to the user.

Some embodiments include a non-transitory computer storage medium storing computer-executable instructions that, when executed by one or more processors, causes the one or more processors to perform operations comprising: determine that a credit file of a user does not include any tradelines by accessing the credit file of the user; access transaction data of the user via an API communication channel established with one or more databases associated with a third-party entity storing the transaction data; identify a new tradeline for a set of transactions within the transaction data that collectively relate to a tradeline category; establish an earliest transaction date for the set of transactions as an inferred open date for the new tradeline; and initiating addition of the new tradeline to the credit file of the user, wherein the new tradeline identifies the tradeline category and the earliest transaction date.

In some embodiments, the operations further comprise: receiving credentials from the user for directly accessing, by proxy on behalf of the user via an Application Programming Interface (API), the transaction data associated with the user stored in one or more databases of a third-party entity; and transmitting at least an API token associated with the third-party entity and the credentials to the one or more databases of the third-party entity.

In some embodiments, the operations further comprise identifying a set of transactions within the transaction data that collectively relate to the tradeline category by: categorizing individual transactions of the transaction data into a plurality of categories based on recipients of the individual transactions; and determining that a first category of a set of the transaction data is eligible to be added as a tradeline in the credit file.

### BRIEF DESCRIPTION OF THE DRAWINGS

FIG. 1 illustrates a flow chart depicting a user's experience for growing the user's credit history according to some embodiments.

FIG. 2 illustrates a flow diagram for a credit system to generate a new credit file for the user and enroll the user in credit monitoring according to some embodiments.

FIG. 3A includes a flow diagram for confirming the identity of the individual, generating a credit file for the individual, and recommending new data items for the individual according to some embodiments.

FIG. 3B includes user interfaces for confirming the identity of the individual and generating a credit file for the individual according to some embodiments.

FIGS. 4A and 4B illustrate flow diagrams for new to credit PIN creation according to some embodiments.

FIG. 4C illustrates a flow diagram for new to credit header creation according to some embodiments.

FIG. 5 provides a flow diagram for identifying a new tradeline and generating an inferred open date for transactions according to some embodiments.

FIG. 6 illustrates a flow diagram for accessing transaction data of a user via an Application Programming Interface (API) channel according to some embodiments.

FIG. 7 illustrates user interfaces for providing user recommendations according to some embodiments.

FIG. 8 provides a flow diagram for inferring and nulling open dates according to some embodiments.

FIG. 9 provides a flow diagram for adding tradelines until the user has a credit score according to some embodiments.

FIG. 10 provides a flow diagram for alerting the user that the user is no longer scorable after deletion of a tradeline according to some embodiments.

FIG. 11 is a block diagram of an example implementation of a credit system in communication with a network and various systems, according to some embodiments.

### DETAILED DESCRIPTION

There are 26 million credit invisible adults, or invisibles (e.g., individuals without credit files). A credit system as described herein can provide consumers features to enable them to initiate a credit bureau system to generate a credit file and to then enable the user to allow the system to add a tradeline to the credit file, such as by applying for a new tradeline or adding existing tradelines that show good payment history in transaction data to the credit file. Moreover, these invisibles can gain access to financial services and/or products that were not previously available prior to the generation of the credit file.

Systems and methods described herein improve on traditional credit systems by providing products and features for invisible consumers to add tradelines through assessment of transaction data, apply for curated credit card offers, and provide steps to improve the likelihood that their first credit score will be an improved credit score instead of an initial credit score using traditional systems with an already negative impacting inquiry on the credit file.

In some embodiments, the credit system can target certain focus groups. The focus groups can include invisibles over the age of 25, young adults, and/or individuals new to the United States (or other country in which a relevant credit bureau operates). The first focus group, invisibles that are over 25 years old, can include individuals who may have failed to make credit a priority early on, are unreceptive to credit features, or have actively opted out of such credit features, and thus may be a focus group that has, at a later stage in life, understood the importance of credit. The second focus group can include young adults who know little about the credit system where willingness to access and create credit can be less of a barrier. The third focus group can include individuals who are new to the United States, such as recent immigrants who have credit from a prior country but not in the United States, and may not have a social security number or credit in the new country where they are residing.

### Example Illustrative Flow From Invisible User to Scorable

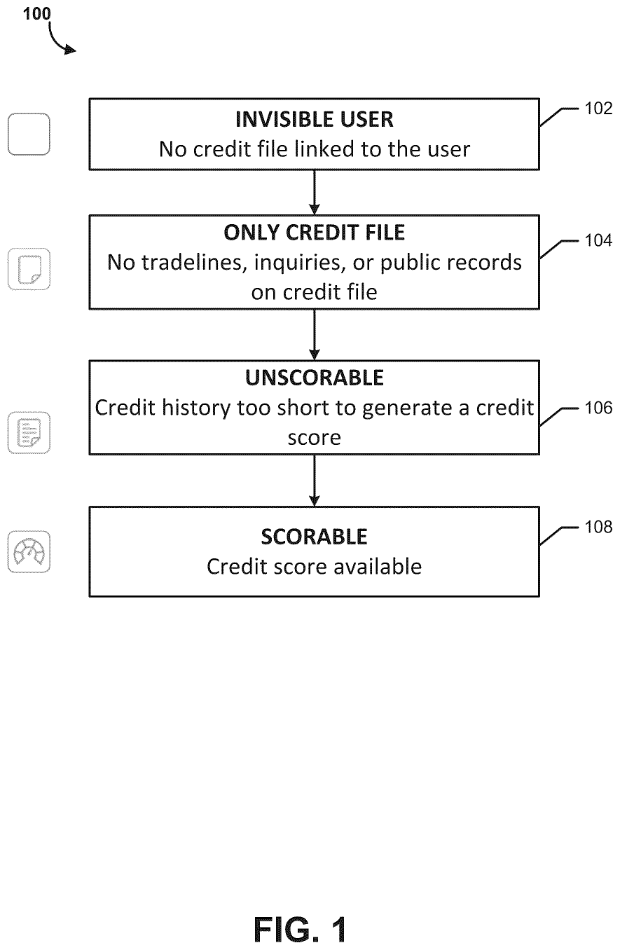

FIG. 1 illustrates a flow chart 100 on the user's experience or stages for growing the user's credit history according to some embodiments. Initially at block 102, the user is an invisible, without a credit file. At this stage, the credit system can generate a credit file for the user, as noted herein.

In some embodiments, the individual can transition to the “Only Credit File” phase at block 104 where the individual has a credit file (such as at least credit “header” information including identifying information for the individual), but no tradelines, inquiries, or public records on their credit file or report. In time, more accounts, tradelines, inquiries, and public records can be added to the credit file. For example, transactions of financial institutions can be assessed to identify new accounts that show timely payment to add to the credit file or a new tradeline can be opened by the user. Thus, the user can help a credit bureau to populate a credit file (e.g., add tradelines) by providing access to transactions of financial institutions. For example, the credit system can display a user interface to request credential information for an account of a user for a financial institution and the credit system can access transaction data via a secure communication channel with the financial institution system or server.

In some embodiments, the account can include transactions by the user with a financial institution, such as a bank. The credit system can receive authorization to access transactions by the user and access the transactions in the financial institution account. The credit system can infer an account between a third-party (such as a utility company, a landlord, or a streaming service) and the user by applying an account identification rule to the transactions in the financial institution account. The credit system can recommend adding the inferred account to the credit file of the user, and thus, improve the status of the credit file.

In some embodiments, with the addition of the inferred account, the individual can transition to the “unscorable” phase at block 106 where the credit history includes some data, such as a few trade lines, but the credit file is still too short for a credit score to be generated. As time progresses or as the credit system adds more tradelines for the user (e.g., recommending new credit cards, identifying more accounts in the user's transaction data to add), the credit file can expand, and the individual can transition to the “scorable” phase at block 108 where a credit score can be generated for the individual.

In other embodiments, as will be further discussed below, consumers that are in the “only credit file” category may be provided an opportunity to generate their first credit score right away. Advantageously, using approaches that will described further below, it is possible for someone who is new to credit to also see their first credit score in the same user session (e.g., in the same browsing session on a website) in order to go from having no credit file to becoming scorable in a matter of minutes in some instances. The credit system can display user interfaces that collect user information (e.g., user input, pictures of user identification documents or the user themselves), verify the user, open a credit file, recommend applying for a new credit card, connect to the user's financial institution account to access transaction data in order to identify accounts to add, apply a scoring algorithm, and provide the user's credit score all within the same browsing session.

The credit system can generate a graphical user interface and/or graphical user interface data that optimizes valuable user interface real estate. For example, the credit system can provide a handful of user interfaces to gather information from the user (such as personal information, images of documents or the user, credentials for user accounts). The credit system can generate a credit file, add tradelines (such as via new credit cards or by assessing transaction data to identify tradelines that can be added to the credit file), and apply a scoring algorithm to generate a credit score, all of which could be performed within the same browsing session on a website.

Such an improved display interface allows a user to more quickly access certain functions, such as enabling the credit system to access of the transaction data from third party financial institutions, storing such transaction data and categorizing the transaction data to identify a set of data corresponding to a category that is eligible to be added as a new tradeline into a credit file, in order to obtain a credit score. The user interfaces 706 and 708 (described in further detail below) illustrate visual indicators that include selectable functions (e.g. a button, a summary list, text, and/or radio button) or inputs of credentials that initiate an API communication channel with the financial institution to access the transaction data (described in further detail herein). The API communication channel is established between the credit system and the financial institution by sending the user's credentials and an API token to the financial institution.

Moreover, the user is saved from paging through multiple screens of financial institution websites that have their transaction data with websites corresponding to credit data, such as a credit bureau website, where the user interfaces described herein can enable the credit system to access relevant transaction data in response via a single user interface and a few clicks of the user. The credit system can display on their website options for the user to select which would connect the credit system with financial institution systems, separate from the communication channel between the credit system and the user.

Another advantage is that the consumer may be able to reach scorable status in this manner without taking on any debt. Accordingly, the consumer could start a browser session at the invisible stage or at the “only credit file” or “unscorable” stage and arrive at the scorable stage in the same browser session, based at least in part on the system adding tradelines to a credit file from an automated analysis of the consumers' transaction data (similar to credit boosting features described in co-owned U.S. application Ser. No. 16/445,647, for which the entirety of the disclosure is hereby incorporated herein by reference).

### Example Illustrative Flow to Generate a Credit File and Enroll in Credit Monitoring

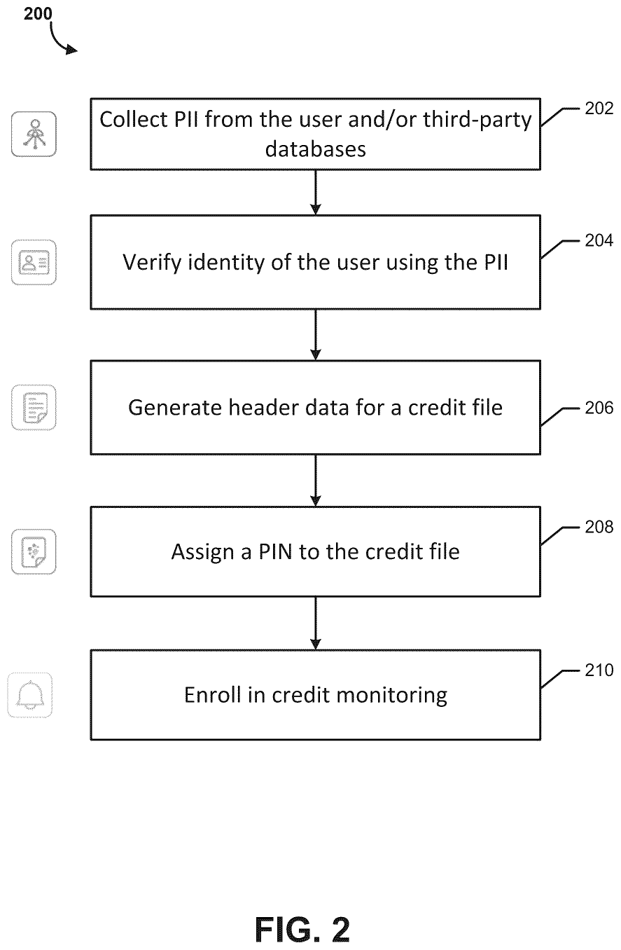

FIG. 2 illustrates a flow diagram 200 for the credit system to generate a new credit file for the user and enroll the user in credit monitoring according to some embodiments. At block 202, the credit system can collect Personal Identifiable Information (“PII”) from the individual, which may include a name, address, social security number (or other government-issued identification number), and/or other PII. The credit system can display a user interface on a computing device of a user, wherein the user interface includes a request for PII information. For example, the credit system can request the individual to fill out a form of questions and answers requesting PII and/or can request upload of a digital image, such as an image of the user's driver's license, passport, or other government issued Identification Document (“ID”).

In some embodiments, the credit system can access a third party database for user information (such as a credit file database, a government database, or a public records database). The credit file database can include credit files of individuals. The credit system can check whether the individual has a credit file by checking whether a credit file exists for the individual, such as by looking up the user's name, address, birth date, social security number and/or other provided information.

In some embodiments, if no credit file exists for the individual in the credit file database, the credit system can initiate the workflow to generate a new credit file for the individual. At block 204, the credit system can verify the identity of the individual. The credit system can verify the identity of the individual based on the received PII information. The credit system can check whether the name of the individual has been associated with the address by checking external sources. For example, the credit system can access third party databases to see if the individual “John Smith” lives on “123 Dale St., Irvine, CA 12345.” The individual may have provided their legal name and address to other third parties, such as banks or car dealerships, or other third parties in the past and/or for other reasons, and the third parties may either have made this information available in public records or accessible by the credit system.

In some embodiments, the credit system can validate all or a subset of the individual's provided PII, such as a social security number. The credit system can access a government database. For example, the government database can include profiles of individuals, each profile including a name, birthdate, and social security number, in some instances. The credit system can verify that the individual's PII matches a profile stored in the government database, such as by matching the name, birth date, and social security number provided by the individual with a profile. The credit system can verify that the name and social security number provided by the user via the computing device matches the name and social security number in the government database.

In some embodiments, the credit system can further check whether certain requirements are met, such as whether the individual is at least 18 years old, before generating a credit file for the user.

In some embodiments, at block 206, the credit system can generate a header file. At block 208, the credit system can assign a PIN to the credit file or header file. In some embodiments, generation of the header file includes generation of a personal identifier or PIN (which may be an abbreviation of Personal Identification Number, but may be numeric, alphanumeric or in another format). In some embodiments, the PIN may be a unique number or alphanumeric string within the credit system that has not been assigned previously to any other individual, such that it uniquely represents the individual and/or the individual's credit file. In some embodiments, the header file or header portion of a credit file may include PII regarding the individual. For example, as is known with respect to credit files maintained by credit bureaus in the United States, header data associated with a credit file may include name, address, date of birth, and social security number, and may also include phone numbers, a driver's license number and/or other personal information. The header data would typically not include tradelines themselves, which is one way that header data is distinguished from other portions of the credit file (e.g., the header data may be used for identification purposes but is not itself indicative of creditworthiness).

In some embodiments, the credit system can generate the personal identifier via a PIN-creation Application Programming Interface (“API”). The credit system can receive PII as noted above. The credit system can check for minimum requirements, such as whether the individual is at least 18 years old, whether PII was provided (such as a name, address, date of birth, and social security number), and/or the like.

In traditional systems, when a person without a credit report provides PII to a third-party merchant or lender, a credit report can ultimately be created (e.g., from a credit inquiry to a credit bureau being initiated by the lender and the bureau then adding record of the inquiry to a new credit file), but the new credit file can include a negative impact on the person's ability to be credit scorable because of the inquiry itself (e.g., the inquiry negatively impacts the credit file). In contrast, the credit system described herein can advantageously provide identity verification to be completed online and create a credit file without a negative inquiry on the new credit file.

Moreover, the credit system can provide features that were not previously available to the user before the credit file existed and allow the consumer to establish a credit report with tradelines, instead of a new credit file with negative credit score impacts as there was no inquiry stored by the credit bureau. Furthermore, the credit system can provide a curated experience and additional information to help build the consumer's newly created credit file. The credit system can then access the PIN-creation API to generate a personal identifier for the individual. The personal identifier can be used to activate the credit file for the individual.

In some embodiments, the credit system can transmit the PIN to third parties for the third parties to verify individuals applying for their goods and services. The third parties can use the PIN to perform certain features, such as to request or pull a credit file of an individual. In some embodiments, the credit system can store the correlation between the individual's identity information and the PIN internally, such as by assigning the PIN to the user's credit file or credit record. The credit system can perform identity verification for other third parties that want to verify the identity of an individual or perform credit monitoring of the individual via the PIN.

The credit system can recommend features that were not previously available to the individual without a credit file. For example, at block 210, the credit system can enroll the user in credit monitoring, provide recommendations to improve the credit file in order to get a credit score, add existing tradelines to the credit file, recommend tradelines or credit cards based on a match of the information available in the credit file, and/or the like. Some embodiments of the credit system can include features disclosed in U.S. application Ser. Nos. 16/445,647 and 16/685,481, which are hereby incorporated by reference in their entirety, which include features to improve a credit file.

### Example Illustrative Flow to Confirm the Identity of an Individual, Generate a Credit File and Recommend Data Items

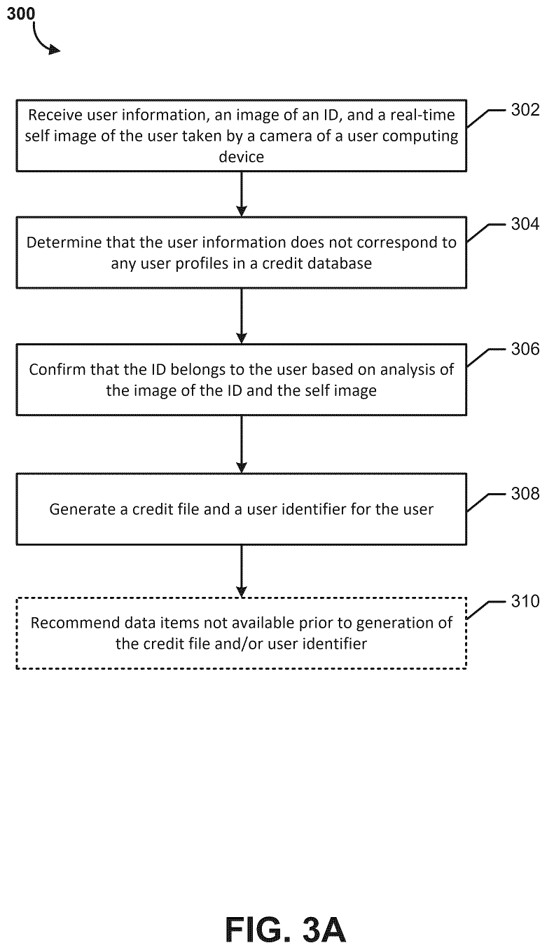

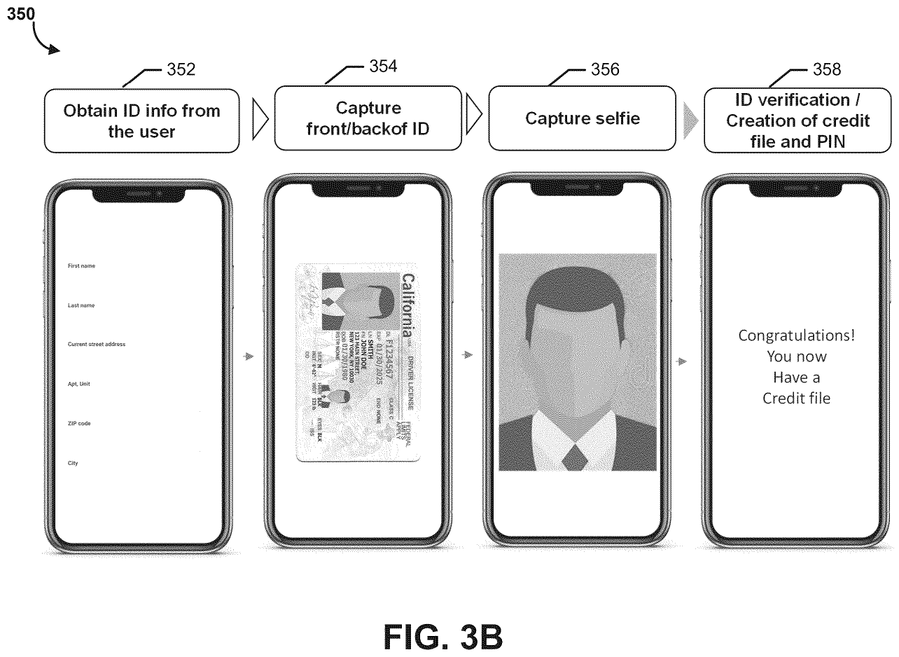

FIG. 3A includes a flow diagram 300 for confirming the identity of an individual, generating a credit file for the individual, and recommending new data items for the individual according to some embodiments. FIG. 3B includes user interfaces 350 for confirming the identity of the individual and generating a credit file for the individual according to some embodiments.

In some embodiments, the credit system can verify that the individual that is applying for the credit file is actually the individual. At block 302, the credit system can request user information, an image of an ID, and/or a real-time self-image of the user taken by a camera of a user computing device.

In some embodiments, the credit system can display a user interface, such as user interface 352, requesting information on an individual, such as a name or address. The credit system can display another user interface (or within the same user interface) requesting further identity verification information, such as a birthdate and social security number, and offer to verify the identity of a consumer. The credit system can request an image of an Identification Document of the user such as via user interface 354. The credit system can access or initiate access to a camera of a user computing device, such as the camera of a mobile phone. The credit system can request an image of the front and back side of an ID, such as a driver license.

In some embodiments, the credit system can request a selfie (e.g., a user taking a photo or picture of his or her own face), such as a live image of the individual, to be uploaded. The selfie image can be captured by a camera of the individual's computing device, such as a mobile phone. For example, the credit system can initiate display of user interface 356 for capturing a selfie image of the user. The credit system can display a user interface to initiate the capture of a selfie image or a life stream video. The credit system can access the camera and automatically or in response to a user interaction with a user interface element, initiate the capture of the image or the real-life stream video.

At block 304, the credit system can determine that the user information does not correspond to any user profiles in a credit database. For example, the credit system can compare the user information (such as social security number, name, address, etc.) received in block 302 with user profiles in a credit database. The credit system can determine that the user information does not correspond to any user profiles in the credit database and conclude that the user does not have a pre-existing credit file.

At block 306, the credit system can confirm that the ID belongs to the user based on an analysis of the image of the ID and the selfie image. The credit system can compare the digital image of the government issued ID with the captured selfie image to determine whether the images substantially correspond to the same individual. If the images substantially correspond above a certain predetermined threshold, the credit system can determine that the individual in the government issued ID is the same person as the individual in the captured selfie image.

In some embodiments, the steps for authenticating that a user really is the person shown on a government-issued identification document (such as based on receiving and analyzing image data of the user and the document) may be performed by a partner service or other third party system that communicates with the credit system (and optionally with the user's device), such as via an API.

In some embodiments, the credit system can extract ID information from the ID. For example, the credit system can perform Optical Character Recognition (OCR) on a driver's license to identify a full name, driver's license number, address, and/or the like. Such information can be used in features described herein, such as verifying this information with user information provided by the user or information in third party databases.

In some embodiments, the credit system can request a live video stream of an individual and/or a video clip, and the live video stream/video clip is assessed to determine whether the individual in the live video stream/video clip substantially corresponds to the individual in the government issued ID.

In some embodiments, the credit system can process the selfie image or video stream with the government issued ID through an algorithm to determine whether the individual in the selfie image or video stream substantially corresponds to the government issued ID. The algorithm can include a machine learning algorithm that is trained to determine whether two images, or an image and a video stream, represent the same individual. The algorithm can be performed by identifying geometry of the face of the individual in the selfie image/video stream and the geometry of the face of the individual in the government issued ID, and comparing the two identified geometries.

Systems and methods described herein include training a machine learning network to compare a government issued ID with a selfie. The machine learning network can be trained to compare a picture of an ID with a live video stream or a picture of the user via a camera on the user's mobile device. The machine learning algorithm can be trained using historical information that include pictures of IDs and selfies taken of users, and results of whether the pictures of the IDs in-fact correspond to the selfies taken of the users.

Training of models (described above and herein), such as artificial intelligence models is necessarily rooted in computer technology, and improves on models by using training data to train such models and thereafter applying the models to new inputs to make inferences on the new inputs. Here, the new inputs can be a front and back picture of a government issued ID of a new consumer and a selfie taken of the consumer. The trained machine learning model can determine whether the user is in-fact the same person on the government issued ID.

Such training involves complex processing that typically requires significant processor computing and extended periods of time with large training data sets, which are typically performed by large server systems. Training of models can require logistic regression and/or forward/backward propagating of training data that can include input data and expected output values that are used to adjust parameters of the models. Such training is the framework of machine learning algorithms that enable the models to be applied to new data (such as new consumer data) and make predictions that the model was trained for based on the weights or scores that were adjusted during training. Such training reduces false positives and increases the performance of correct user authentication.

At block 308, the credit system can generate a credit file and/or a personal identifier (such as a PIN). The credit system can display a notification to the user, such as user interface 358, that indicate completion of ID verification, creation of a credit file, and/or creation of a personal identifier or PIN.

At block 310, the credit system can recommend data items that were not previously available to the user prior to the generation of the credit file and/or the personal identifier. For example, the credit system can enroll the user in credit monitoring, provide recommendations to improve the credit file in order to get a credit score, add existing tradelines to the credit file, recommend tradelines or credit cards based on a match of the information available in the credit file, and/or the like.

### Example Illustrative Flow For New To Credit Pin Creation

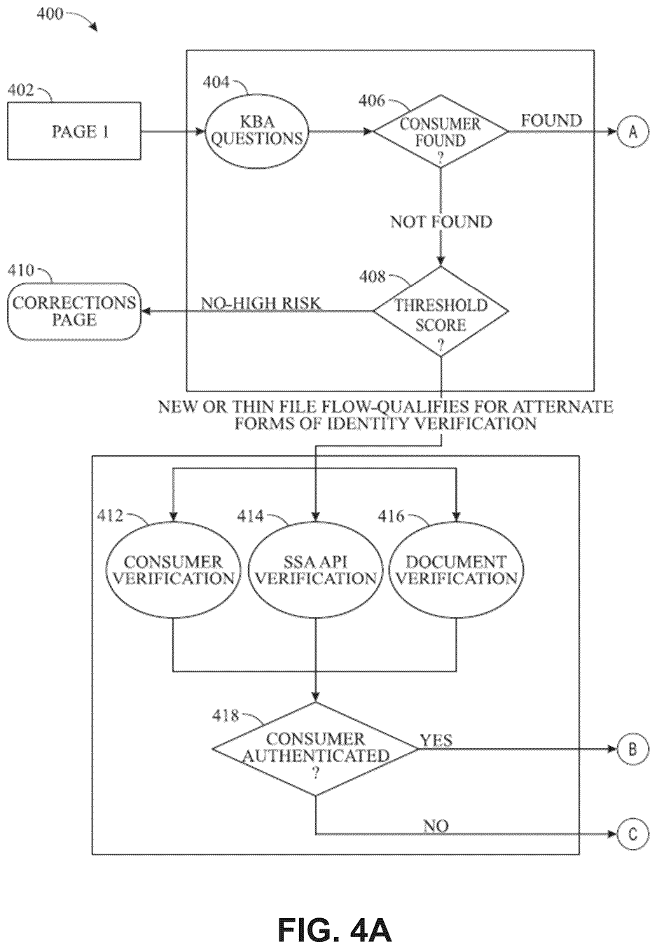

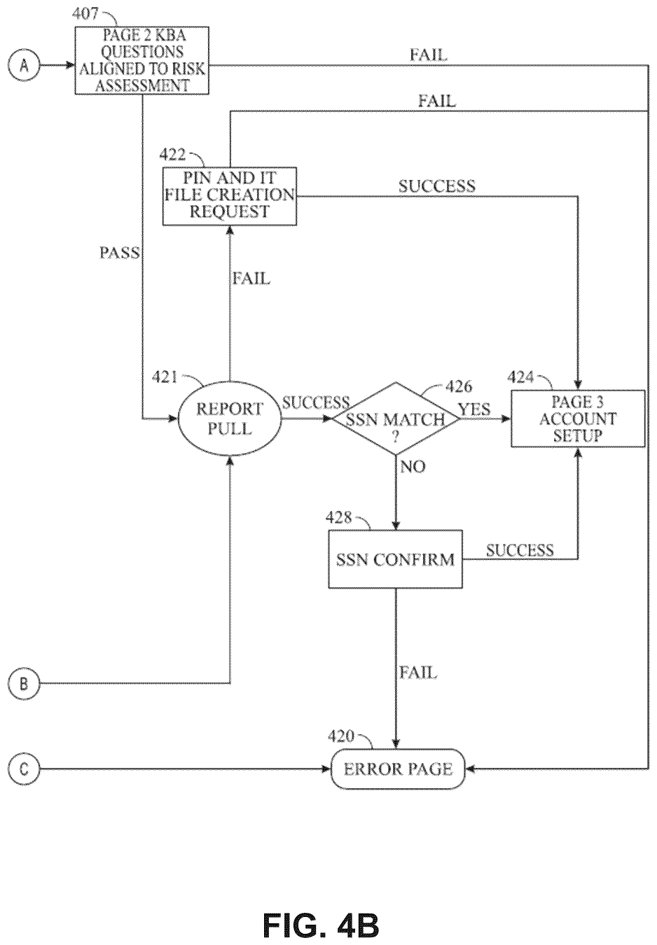

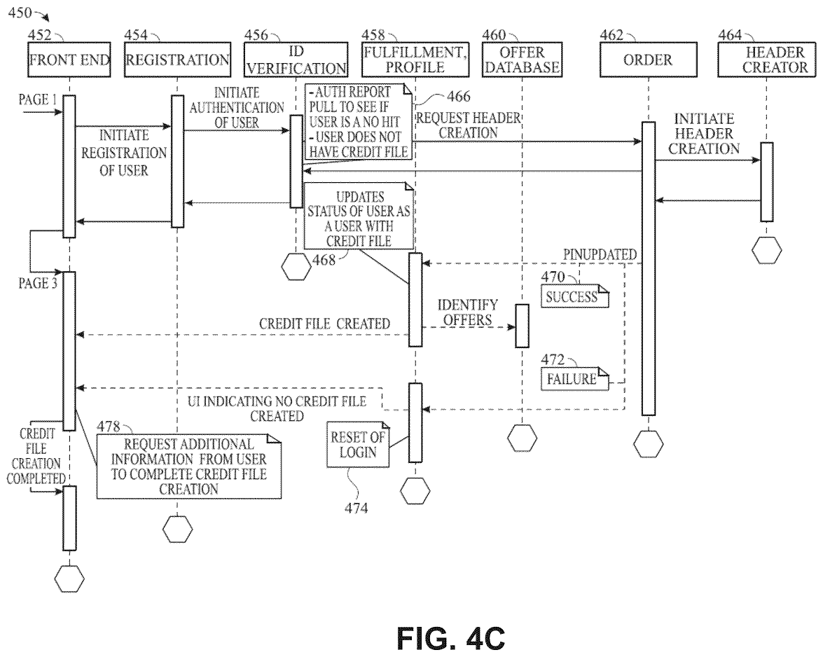

FIGS. 4A and 4B illustrate a flow diagram 400 for new to credit PIN creation according to some embodiments. At block 402, the credit system can request for information from the user, such as via a user interface on page 1. The user interface can request a consumer to provide Personal Identifiable Information (PII), such as a name, address, Social Security Number (SSN), Date of Birth (DOB), email, phone number, and/or the like, and/or the users can set up credentials for returning use. The pages and flow for data collection can differ between types of computing devices, such as between a web browser and a native application.

In some embodiments, the credit system can take this information and determine whether records exist for the user, such as by checking the credit database to see if a credit file exists. At block 404, the credit system can ask certain questions and perform authentication of the user, such as via Knowledge-based Authentication (KBA). The credit system can authenticate the user by using knowledge of private information of the user to prove that the person providing the identity information is in-fact the user.

In some embodiments, the credit system can determine whether the consumer is found, such as in block 406, by searching information related to the consumer in third-party databases, such as in public records databases. If the user is found, the credit system can proceed to block 407, where the credit system displays a user interface, such as page 2, where KBA can be performed to assess risk for the consumer. If the user fails the risk assessment, at block 420, the credit system can display an error page to the user and/or indicate that the user could not pass the risk assessment for a new credit file. If the user passes the risk assessment, at block 421, the credit system can attempt to pull a credit report of a user.

If a credit file is not found at block 406, the credit system can determine a fraud risk score by linking patterns in the PII to generate a fraud score. At block 408, the credit system can determine if the user is high or low risk by assessing the fraud score with a threshold score. If a fraud risk score is higher than a certain threshold, then at block 410, the credit system can redirect the user to a corrections page where more information from the consumer is requested to verify the user's identity or notify the user that the user is not eligible for a credit file.

At block 412, 414, and 416, the credit system can begin verifying the user. At block 412, the credit system can verify the user based on information provided by the consumer, such as by verifying that the PII of the user matches the information stored in public records. At block 414, the credit system can verify the user based on information from third party databases, such as by verifying the social security number of the user via government databases (e.g., Social Security Administration API verification).

At block 416, the credit system can verify documents or images provided by the user, such as by verifying that the individual on a selfie image or video stream is the individual on a government issued ID.

If at block 418, one or more of the processes are invalid, then the consumer can be considered not verified, and at block 420, the credit system can display an error page to the user and/or indicate that the user could not be authenticated.

If at least one or all three processes are valid, the user can be considered authenticated at block 418. If the user is authenticated, at block 421, the credit system can attempt to pull a credit report of a user and/or the credit system can request a credit score for the user via a credit bureau.

If the credit report request fails, at block 422, the credit system can determine that the user does not have a credit file. The credit system can generate (or initiate the generation of) a credit file for the user by creating a PIN and/or create the PIN to generate the credit file. If the creation of the PIN and/or the credit file fails, at block 420, the credit system can display an error page to the user and/or indicate that the credit file or PIN could not be generated.

Upon the creation of the PIN, at block 424, the credit system can display a user interface, such as page 3, that includes steps to generate or set up an account. The credit system can display additional user interfaces, such as information on how to add tradelines to the credit file or other steps for the user to input information to formally set up a credit file.

At block 421, if a credit report exists, the credit system can determine whether there is a match in the social security number of the user, such as by checking all 9 numbers or a subset of the numbers of the social security number, in block 426. If there is a social security match, then the credit system can display an account setup user interface, such as in block 424.

If not, then at block 428, the credit system can request further information, such as requesting the user to confirm their social security information. If then the social security number is confirmed, the credit system can display the account setup user interface, such as in block 424. If not, the credit system can display an error message and/or an indication that the social security could not be verified at block 420. It will be appreciated that depending on the country or jurisdiction in which the credit system operates, a different government identification number or personal identifier may be utilized rather than a social security number, which may be specific to the United States.

### Example Illustrative Flow for Header Creation

FIG. 4C illustrates a flow diagram 450 for new to credit header creation according to some embodiments. The credit system can display a user interface to a user computing system via the front end module 452. The credit system can receive user PII, a document to be verified, such as an image of a driver's license, a selfie image, or a selection to create a new credit file.

In some embodiments, the front end module 452 can initiate registration of the user by sending a message to a registration module 454. The registration module 454 can then begin registration of the user, such as by storing certain information of the user and/or determining what information is available of the user, such as information stored internally, information received by the user, and/or information located in third party databases.

In some embodiments, the registration module 454 can initiate authentication of the user by transmitting a signal to an ID verification module 456. The ID verification module 456 can attempt to retrieve an authentication report and/or perform authentication of the user at block 466. The ID verification module 456 can also determine whether the user has a credit file and/or request a credit file of the user in order to make that determination (e.g., if a request was denied for not being in the credit bureau database). The credit system can request verification of a document, such as a government issued ID, selfie, or user information to verify and/or authenticate the user.

In some embodiments, if the user does not have a credit file, the ID verification module 456 can transmit a request to create a header file for the user. The order module 462 can receive the request to create a header file and initiate header creation with a header creator module 464. The header creator module 464 can send a completion message back to the order module 462. The order module 462 can then assess whether the header was created and/or whether a PIN that was generated with the header is available for the user. The order module 462 can send a message to the ID verification module 456 with an indication of whether the header and/or the PIN was requested or created, such as in the message 470 if the credit file was created, or message 472 if the credit file was not created.

In some embodiments, the ID verification module 456 can send a message to the front end module 452, such as via various modules (e.g., the registration module 454), providing an indication on whether the credit file and/or PIN was created. The front end module 452 can display a user interface, such as page 3, indicating that a credit file has been opened for the user.

In some embodiments, if the PIN and/or the credit file was created, the order module 464 can receive this completion notice from the header creator module 464, the order module 462 can indicate that this has been completed to a fulfillment and profile module 458, and the fulfillment and profile module 458 can send a request to an offer database module 460 in order to identify whether offers are now available for the user. For example, the user may not have been qualified to receive certain credit card offers. But with the generation of the credit file via the header and/or PIN creation, the offer database module 460 may determine that the user is now be eligible. The fulfillment and profile module 458 can set a status of the user as a user with a credit file in process 468.

In some embodiments, the fulfillment and profile module 458 can send a message to the front end module 452 that the header and/or PIN was created. The fulfillment and profile module 458 can also send a message to the front end module of any new offers that are now available to the user. The front end module 452 can display new offers that the user is available, now that the credit file has been opened. The user can complete their user profile, such as setting up a password recovery option.

In some embodiments, the credit system can initiate other options for the user upon successful identity verification and credit file generation, such as by initiating a user experience. The credit system can then send the PIN to the individual, use the PIN for features such as credit monitoring, and/or send the PIN to third-parties (e.g., for third-parties to use when retrieving a credit file for the user). When the PIN is created, offers can be activated, such as syncing bank accounts to see if a tradeline can be added to the credit file, recommending credit cards based on the new credit file, providing additional information on credit, and/or the like that would not have been available to the user (e.g., the user may not have been eligible for these features) prior to the generation of the credit file.

In some embodiments, if the PIN and/or the credit file was not created, the fulfillment and profile module 458 can send a message to the front end module 452 providing an indication that the credit file and/or PIN was not created. The fulfillment and profile module 458 can reset the login of the user at process 474, requiring the user to login again and/or send an email to reset their password. The front end module 452 can display a user interface indicating that no credit file has been created and request the user to submit additional information to complete credit file creation in process 478. Upon successful completion of receiving additional information to complete the credit file creation, the front end module 452 can display a user interface indicating that the credit file has been successfully completed.

### Example Illustrative Flow for Adding New Tradelines and Inferring Open Dates

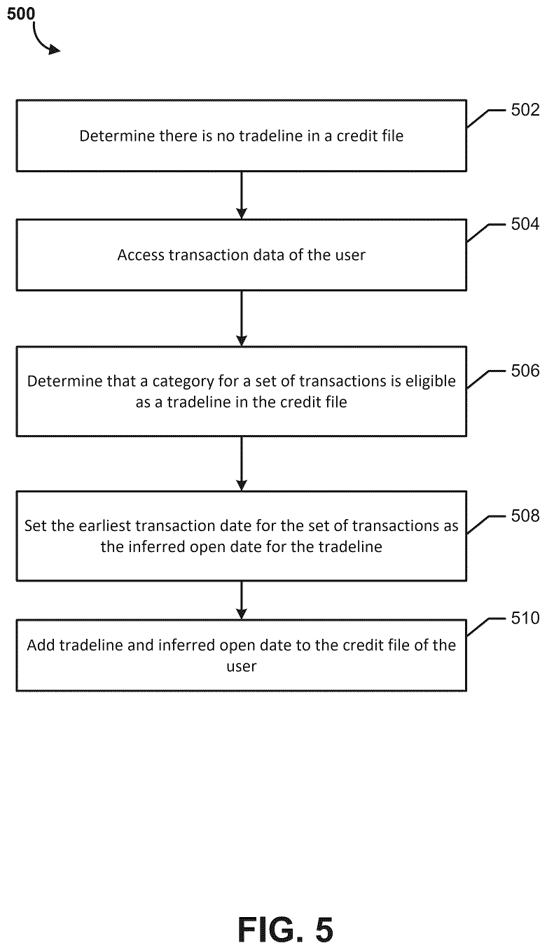

FIG. 5 provides a flow diagram 500 for identifying a new tradeline and generating an inferred open date for transactions according to some embodiments. At block 502, the credit system can determine there is no tradeline in a credit file. For example, the credit system can generate a new credit file via the process described in FIG. 4C. The credit system can also communicate with a new or pre-existing user and determine that the user does not have any tradelines on their credit file. The user can be an “only credit file” status, such as block 104 in FIG. 1.

In some embodiments, at block 504, the credit system can access transaction data of the user via an API channel (as further described below). The transaction data may be standardized. The transaction data stored in a financial institution database can include transactions between the user and a payee (e.g., a streaming service, utility company, rental company, etc.). The credit system may standardize payee data for the particular payee, such as a standardized identifier for a particular payee that may be associated with various adaptations of payee information for that particular payee. For example, a standardized identifier for a payee (for example, “Southern California Power Co.”) may be associated with multiple variations of payee information that could be used by different financial institutions in identifying transactions with that payee (for example, “SCP”, “So Calif Power”, and so forth). Thus, through standardizing payee information of transaction data items, matching of transaction, even from multiple financial institution accounts of the user, may be associated as payments to a particular account.

Because the transaction data is coming from an external database, the credit system can standardize information in the transaction data to conform with the format of the credit system database and/or a credit bureau database. As such, when a new tradeline is added, such as by sending a request to a credit bureau's system, the format can be aligned with the credit bureau's database for accurate addition of the tradeline. Moreover, the credit system can verify whether the newly identified tradeline is already in the credit file after standardization of the payee information. For example, the credit file may have “SCP” as a tradeline but the transaction data may have “Southern California Power.” Performing standardization of the transaction data to “SCP” can help the credit system to identify that the tradeline already exists in the credit file.

At block 506, the credit system can determine a category for a set of transactions or determine for all transactions, corresponding categories. The credit system can determine that a set of transactions correspond to a category eligible to add as a tradeline in a credit report.

In some embodiments, the credit system may access the transaction data, and identity groupings (also referred to as “subsets”) of data items each associated with a common entity. For example, multiple data items of a user stored in a third-party database may be included in a grouping. The credit system can then apply rules to the groupings of data items to identify groupings that match one or more patterns indicative of groupings of data items that could be a potential tradeline.

In some embodiments, the credit system trains and/or applies one or more models (such as machine learning models or neural networks) configured to categorize transactions. Such models can be trained to categorize transactions across multiple months or years of transactional data of the user. For example, in some embodiments, the credit system may identify transaction data items of a user that occur with a certain periodicity, within a certain monetary range of one another, with certain keywords or characters in the payee's name (or other information, such as a memo or “for:” information field provided by the user), and/or any other attributes that may be associated with transaction data for the user. Data item groupings may then be created to indicate sets of data items that are believed to be associated with a particular account of the user. In some embodiments, each data item groupings are associated with a different payee.

In some embodiments, the credit system may associate an account type with each identified account (for example, each grouping of data items for particular payees) in the user's transactional data. For example, a first identified account (for example, associated with 24 separate monthly payments identified in Bob's checking account data) may be indicated as a rental type account. Account types may include a general account type (for example, telecom, utility) and/or a specific account type, or may have additional levels of categorization. For example, telecom account types may be further categorized as mobile phone, phone, internet, cable, or satellite accounts, while utilities account types may be further categorized as gas, electric, water, power, solar, or trash account.

In some embodiments, the system may identify monthly recurring transactions made to the same payee as being categorized together and associated with a single account (for example, an electric, water, or wireless account). Additionally, the system may identify a second set of transaction data items made to another payee and, based on account identification rules, determines that the second set of transaction data items are associated with a rental account of the user.

In some embodiments, the credit system already knows that the credit file does not include any tradelines. In other embodiments, the credit system can check the credit file to determine whether a tradeline is already in the credit file that corresponds to the same category as the set of transactions and/or to the same merchant for the set of transactions.

Existing and common credit scoring algorithms typically have minimum criteria that must be met before a given individual's credit file is eligible for scoring. One example credit scoring algorithm may not generate a credit score unless a person's credit file includes at least one line of credit with an open date (e.g., the date indicating when the line of credit was opened with a financial institution) going back at least seven months from the current date.

However, tradelines added to a credit file by analyzing consumer permissioned data (CPD) according to prior methods do not include an open date (which would typically be provided by a reporting creditor in traditional credit reporting, but are not clearly listed in CPD transactions). As a solution to these issues, aspects of the present disclosure include setting an open date for certain CPD tradelines, such as if no other line of credit is available for the given user.

In some embodiments, at block 508, the credit system can identify the earliest transaction date for the set of transactions and set the earliest transaction date as the inferred open date. It will be appreciated that this is an inferred date and may not precisely be the actual open date for the account (e.g., because the retrieved transaction data may only go back a certain amount of time from the present date, or the consumer may have made earlier payments from a financial account that is not included in the available transaction data). At block 510, the credit system can then add or request the addition of a tradeline that corresponds to the category for the set of transactions. The credit system can request to add the inferred open date with the tradeline when the tradeline is added to the credit file of the user.

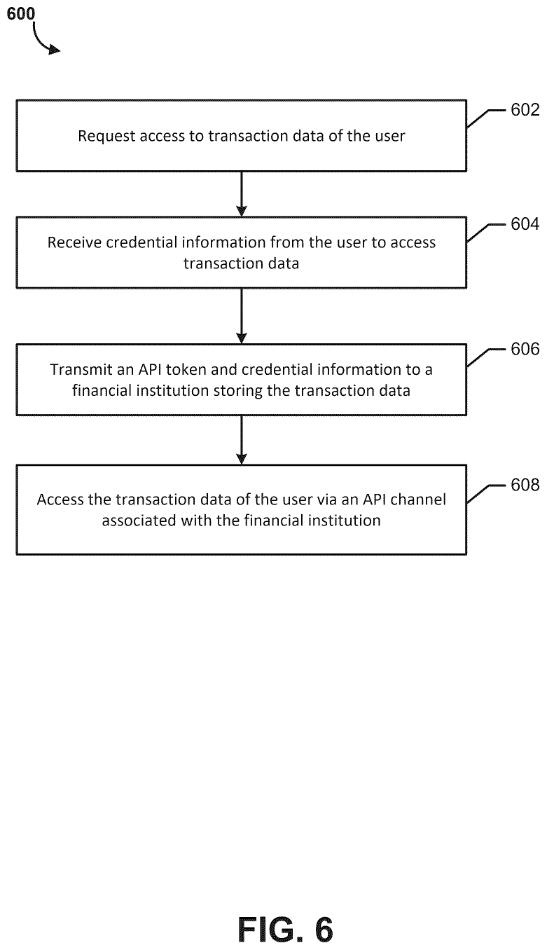

FIG. 6 illustrates a flow diagram 600 for accessing transaction data of a user via an Application Programming Interface (API) channel according to some embodiments. At block 602, the credit system can request access to transaction data of the user. The credit system can request that the user select one or more financial institutions where the user has an account (e.g., a checking or debit account).

In some embodiments, the credit system can request credential information from the user for the user's account with the financial institution, such as a login and password. At block 604, the credit system can receive credential information from the user to access the transaction data.

In some embodiments, at block 606, the credit system can transmit an API token and/or credential information to a financial institution storing the transaction data. Application Programming Interface (API) can include a defined communication channel, protocol, settings, and so forth that allows two devices to exchange information between one another in a more direct manner than might otherwise be possible. In some embodiments, an API registration module may be configured to register individual devices (for example, computing devices, Internet of things devices, sensors, and so forth) for communication with a particular computing device (for example, a central server that receives, processes, stores, provides, information to the individual devices) by issuing a security token (for example, such as an API token or an API key) to the individual devices that authorizes such direct communications. Thus, a computing system may establish secure and direct communication channels with multiple devices via APIs.

In some embodiments, financial institutions that are storing the transaction data can be in communication with the credit system via respective APIs. Thus, data permissioning may be performed via communications with financial institutions that is initiated and authenticated using API tokens, keys, and/or other similar secure communication credentials. For example, a financial institution may be a first financial institution that allows direct access to transactions of its customers via a secure communication channel that is initiated through use of an API token that has been issued to the credit system by the financial institution. In this way, the financial institution maintains security of consumer information by limiting access to the transaction information to only those with a pre-issued API token.

Similarly, communications with other financial institutions may be performed with unique API keys or tokens issues from those financial institutions. In some embodiments, the financial institutions may include, or may use third-party, API token service, which interfaces with external entities, receives authorizations from the external entities indicating that the credit system has sufficient rights to access transaction data items of consumers held by the financial institution, and issues a API token to the credit system usable to initiate a “backend” API communication channel with the financial institution to efficiently and quickly access data to which the credit system is authorized. Thus, in some embodiments the credit system provides the API token issued to the credit system in conjunction with a request for transaction data items of a particular consumer.

In some embodiments, at block 608, the credit system can access the transaction data of the user via an API channel associated with the financial institution storing the transaction data, as further described above.

### Example Illustrative User Interfaces for Recommended Data Items not Available Prior to Generation of Credit File

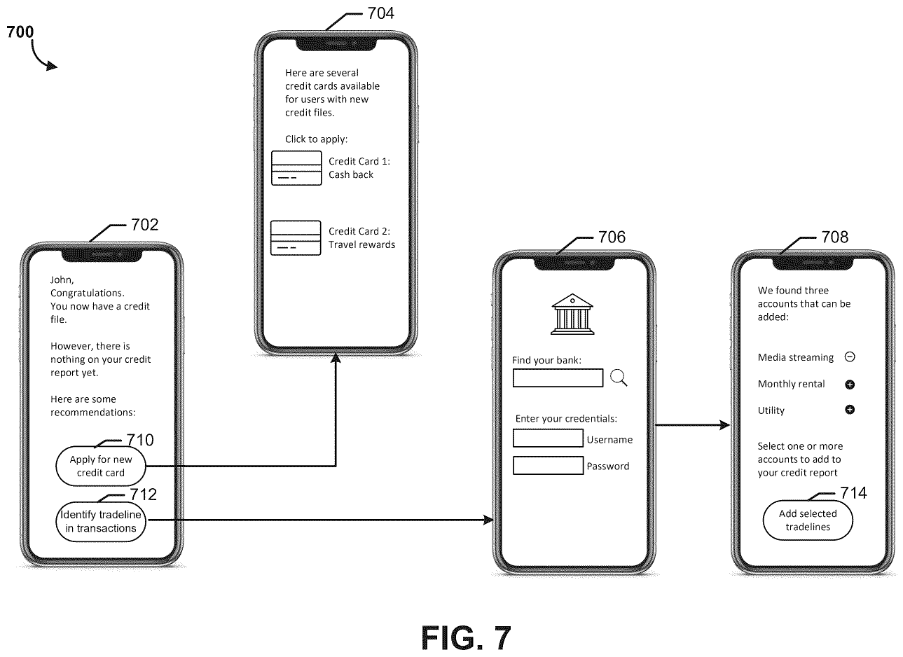

FIG. 7 illustrates user interfaces 700 for providing user recommendations according to some embodiments. Upon completion of the creation of a credit file and/or PIN, the credit system can display a congratulatory user interface 702 for such creation of the credit file. The user interface 702 can display an indication that there is not enough credit history to generate a credit score or other score. The user interface 702 can provide useful information for the user, such as information related to credit data, links to best start building credit, blog articles of relevant content, and/or the like.

In some embodiments, the user interface 702 can provide recommended data items for the user, such as a first selectable user interface element 710 to apply for a new credit card and/or a second selectable user interface element 712 to identify potential tradelines in user transactions that may be eligible to add as new tradelines into the credit file. In some embodiments, the recommended data items are data items that were not available for the user prior to the generation of the credit file.

In some embodiments, the user interface 702 can display a flow of questions for the user to answer in input fields. In response to the user's answers, the credit system can determine whether the user has qualifying accounts to add to the credit file, whether the user is qualified for certain financial products, whether the user has or can become an authorized user, and/or the like. The user interface 702 can provide education on what users with new credit files should know and recommend habits on building a healthy credit file. The user interface 702 can display information that provide more focused and customized information to the individual.

In some embodiments, the user interface 702 can display information educating a user on why they do not have a credit score. The generation of a credit file may not be sufficient to generate a credit score. The credit score algorithm may require more of a credit file with a longer credit file history. The credit system can display user interfaces that explain to an individual why the user doesn't yet have a credit score, and other related information such as when the user can get a credit score or why the score is important.

In some embodiments, if the user selects the first user interface element 710, the credit system can display user interface 704 that includes several credit cards available for the user. The available credit cards can be credit cards that users with new credit files are eligible for, such as Credit Card 1 or Credit Card 2. Based on the user's new to credit status or credit file, the credit system can provide explanatory text on why certain recommended financial features, such as credit cards, are aligned with the user's credit status.

In some embodiments, the user interface 704 can display a marketplace hub for individuals with new credit files that help users build credit. The credit system can display offers such as credit card offers that can help build credit faster. The user interface 702 can display financial products that the user can get approved even with a limited credit file.

In some embodiments, if the user selects the second user interface element 712, the credit system can display user interface 706 that requests the user to identify the financial institution where the user has an account. The user interface 706 can display a request for a user's credentials, such as login or password, to access the transaction data.

In some embodiments, the credit system can access the transaction data, identify one or more potential tradelines to add to the credit file, and display the identified tradelines in user interface 708. For example, potential tradelines can be in the category of media streaming accounts, monthly rental payment accounts, utility accounts, and/or the like.

In some embodiments, the user interface 708 can enable the user to select one or more of the potential tradelines. The user interface 708 can include a user selectable interface element 714 that enables the credit system to add the selected tradelines to the credit file.

### Example Illustrative Flow for Inferring Open Dates and Nulling Open Dates

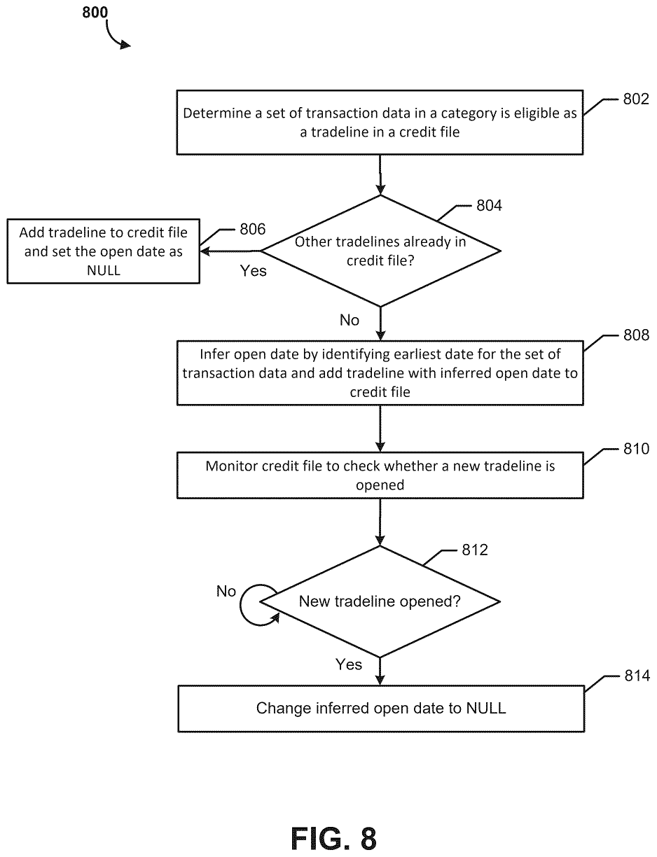

FIG. 8 provides a flow diagram 800 for inferring and nulling open dates according to some embodiments. The credit system can determine whether the user meets one or more of the following criteria: whether the user has no tradelines in the credit file, does not have a credit line, or only has collection trades on their record.

In some embodiments, if the user does not have a credit file, the credit system can initiate processes to recommend opening a credit file to the user. If the user opens a credit file or already has a credit file, the credit system can request to assess transaction data of the user to identify a potential tradeline to add to the credit file.

In some embodiments, at block 802, the credit system can access transaction data of a user, such as via an API channel to a financial institution storing such transaction data and identify a set of transactions that are in a category eligible to add as a tradeline in a credit file. In some instances where a user is already scorable by a credit scoring algorithm, the credit system may be configured not to set an open date for a newly added CPD trade line because the open date may lead to less favorable scores relative to leaving the open date as a null value.

In some embodiments, at block 804, the credit system can determine whether there are other tradelines already in the credit file. If there are other tradelines already in the credit file, at block 806, the credit system can add the tradeline and set the open date as NULL.

In some embodiments, if there are no tradelines in the credit file, at block 808, the credit system can infer an open date for the tradeline by identifying the earliest date for the set of transaction data and add the tradeline to the credit file with the inferred open date.

In some embodiments, this open date for a given trade line or account may be set based on the transactions found for each trade, and the oldest transaction may drive the open date. For example, if the oldest transaction in the set of transactions is from 12 months ago, then that date 12 months ago may be set as the open date for the newly stored line of credit in a credit database (such as a credit database maintained by a credit bureau).

In some embodiments, at block 810, the credit system can monitor the credit file to check whether a new tradeline is opened. At block 812, if no new tradeline is opened, the credit system can check again after a predetermined time period, such as daily, weekly, monthly, quarterly, etc.

In some embodiments, if the credit system identifies a new tradeline in the credit file, at block 814, the credit system can change the previously stored inferred open date to NULL or otherwise delete the stored open date, which may improve credit scoring results in some embodiments.

In some embodiments, the open date can be associated with and/or part of a unique key generated for a tradeline. If the consumer later (whether in the same session or some longer time later) opens a new line of credit (such as signing up for a credit card), the system may subsequently add additional CPD-based tradelines to the credit file without setting an open date on the subsequently added account(s) (e.g., setting a null value for an “open date” field).

In some embodiments, the open date for previously added CPD-based tradelines may be kept even though a new line of credit is opened. In other embodiments, the system may overwrite the previously added CPD-based tradeline's open date to be null (such as if the consumer now has a traditional credit card account on file resulting in the consumer having a scorable credit score).

### Example Illustrative Flow for Steps to Make the User Eligible for a Credit Score

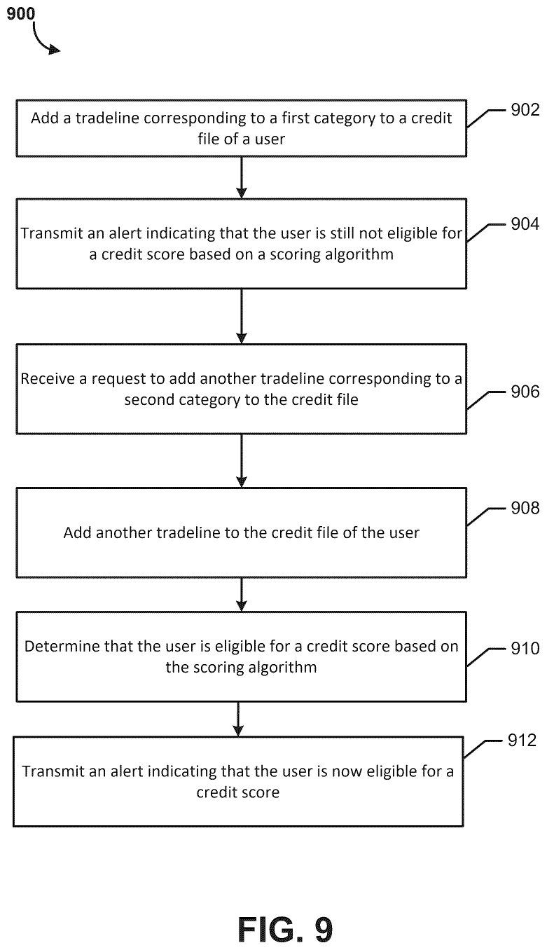

FIG. 9 provides a flow diagram 900 for adding tradelines until the user has a credit score according to some embodiments. At block 902, the credit system may have added a tradeline to a credit file of a user, such as via the other flow diagrams described herein. The credit system may input user credit information, such as information on a user credit file, into a scoring algorithm to determine whether the user is scorable, such as for a credit score.

In some embodiments, at block 904, the credit system can transmit an alert to the user that the user is still not eligible for a credit score. At block 906, the credit system can send a request and the user can accept to add another tradeline corresponding to a category of transaction data that is different than that of the tradeline added in block 902.

In some embodiments, at block 908, the credit system can add the other tradeline to the credit file of the user. At block 910, the credit system can input user information, such as information on a user credit file with the new second tradeline, into a scoring algorithm to determine whether the user is scorable for a credit score. The credit system can determine that the user is eligible for a credit score based on the scoring algorithm, and at block 912, the credit system can transmit an alert to the user indicating that the user is now eligible for a credit score.

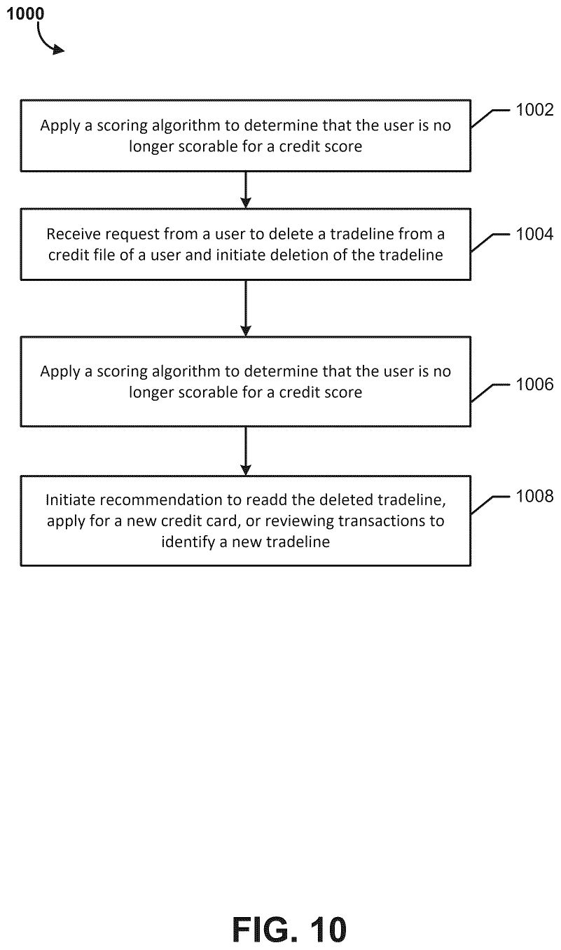

FIG. 10 provides a flow diagram 1000 for alerting the user that the user is no longer scorable after deletion of the tradeline according to some embodiments. At block 1002, the credit system can apply a scoring algorithm and generate a credit score for a user. At block 1004, the credit system can receive a request to delete a tradeline from a credit file of a user and can initiate deletion of the tradeline.

In some embodiments, at block 1006, the credit system can apply a scoring algorithm and determine that the user is no longer qualified for a credit score. For example, with the deletion of the tradeline, the credit file may not have enough history for the scoring algorithm to provide a credit score for the user.

In some embodiments, at block 1008, the credit system can send an alert indicating that the user is no longer scorable and/or providing recommendations such as to readding the deleted tradeline, applying for a new credit card, or reviewing transactions to identify a new tradeline to add to the credit file.

The alerts described herein (including the alerts of FIGS. 9 and 10) can be transmitted over a wireless communication channel. The alerts can activate an installed electronic file (e.g., a mobile application) on the user's mobile device to connect the electronic file in a communication channel with the credit system and/or to initiate a notification on the user's mobile device, such as an SMS message.

Advantageously, the dynamic generation of the alert improves an Internet-centric technical problem that is necessarily rooted in computer technology. In the example of dynamically generating the alert based on identifying that the user is no longer scorable, the user can be immediately notified of this status when the status could be the most relevant to the user, such as if the user is applying for a loan. The alert can also be immediate and real-time of when the user becomes unscorable, providing the user the ability to perform actions to become scorable right away, such as by adding new tradelines via assessing transaction data. Thus, the user can be alerted of the unscorable status when the user is away from the user's home desktop. Moreover, the alert could initiate the user to look at the user's mobile phone (e.g., due to the SMS message) when the user is not currently using the user's mobile phone, providing a practical solution to the technical problem of the user being away from a home desktop or not using the mobile phone.

### Example System Implementation and Architecture

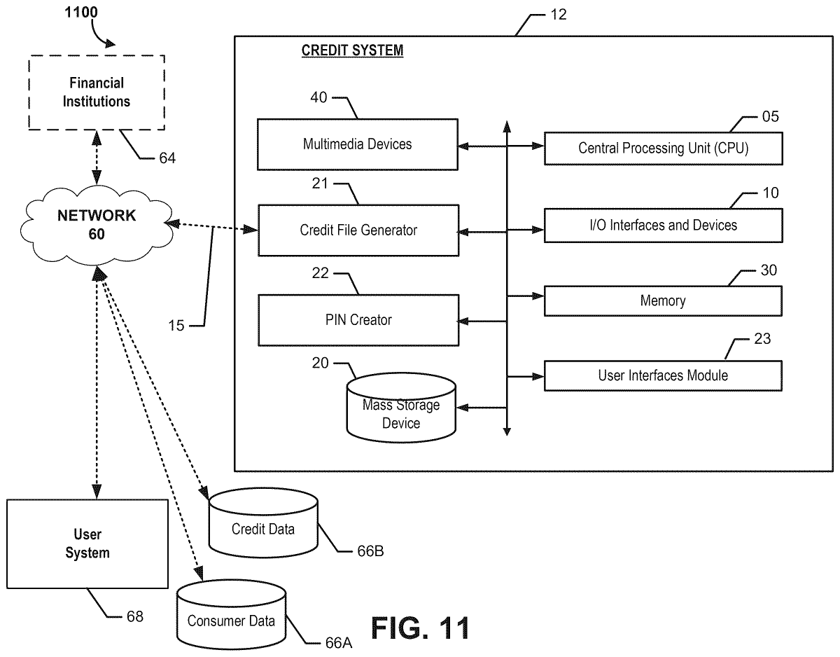

FIG. 11 is a block diagram 1100 of an example implementation of a credit system in communication with a network 60 and various systems, such as financial institution systems 64, user systems 68, and data sources 66A and 66B. The credit system 12 may be used to implement systems and methods described herein.

The credit system 12 includes, for example, a personal computer that is IBM, Macintosh, or Linux/Unix compatible or a server or workstation. In one embodiment, the credit system 12 comprises a server, a laptop computer, a smart phone, a personal digital assistant, a kiosk, or a media player, for example. In one embodiment, the exemplary credit system 12 includes one or more central processing unit (“CPU”) 05, which may each include a conventional or proprietary microprocessor. The credit system 12 further includes one or more memory 30, such as random-access memory (“RAM”) for temporary storage of information, one or more read only memory (“ROM”) for permanent storage of information, and one or more mass storage device 20, such as a hard drive, diskette, solid state drive, or optical media storage device. Typically, the modules of the credit system 12 are connected to the computer using a standard based bus system 80. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of credit system 12 may be combined into fewer components and modules or further separated into additional components and modules.

The credit system 12 is generally controlled and coordinated by operating system software, such as Windows XP, Windows Vista, Windows 7, Windows 8, Windows Server, Unix, Linux, SunOS, Solaris, iOS, Blackberry OS, or other compatible operating systems. In Macintosh systems, the operating system may be any available operating system, such as MAC OS X. In other embodiments, the credit system 12 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary credit system 12 may include one or more commonly available input/output (I/O) devices and interfaces 10, such as a keyboard, mouse, touchpad, and printer. In one embodiment, the I/O devices and interfaces 10 include one or more display devices, such as a monitor, that allows the visual presentation of data to a user. More particularly, a display device provides for the presentation of GUIs, application software data, and multimedia presentations, for example. The credit system 12 may also include one or more multimedia devices 40, such as speakers, video cards, graphics accelerators, and microphones, for example.

In the embodiment of FIG. 11, the I/O devices and interfaces 10 provide a communication interface to various external devices. In the embodiment of FIG. 11, the credit system 12 is electronically coupled to a network 60, which comprises one or more of a LAN, WAN, and/or the Internet, for example, via a wired, wireless, or combination of wired and wireless, communication link 15. The network 60 communicates with various computing devices and/or other electronic devices via wired or wireless communication links.

According to FIG. 11, in some embodiments information may be provided to the credit system 12 over the network 60 from one or more targeting criteria data sources 66A and/or digital identifiers data source 66B. The consumer data sources 66A and credit data sources 66B may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 11, the credit system 12 includes a credit file generator 21, a PIN generator 22, and a user interface module 23 that may be stored in the mass storage device 20 as executable software codes that are executed by the CPU 05. This and other modules in the credit system 12 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 11, the credit system 12 is configured to execute the credit file generator 21, the PIN generator 22, and/or the user interface module 23 to perform the various methods and/or processes for credit file generation and PIN generation as described herein.

### Other Embodiments

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the credit system 12, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be emphasized that many variations and modifications may be made to the above-described embodiments, the elements of which are to be understood as being among other acceptable examples. All such modifications and variations are intended to be included herein within the scope of this disclosure.

1-20. (canceled)

21. A system comprising:
one or more hardware processors comprising a credit file generation processor and a PIN generation processor; and
at least one non-transitory storage media storing instructions that, when executed by the one or more hardware processors, cause the one or more hardware processors to:
receive or access, from a user computing device, Personal Identifiable Information (“PII”) and digital image data comprising a government issued identification document (“ID”), wherein the PII includes a name and an address of a user associated with the user computing device;
determine, by the credit file generation processor, that identification information associated with the digital image data corresponds to the PII;
compare, by the credit file generation processor, the PII with credit files in a credit file database to determine that there is no match;
determine, by the credit file generation processor, that the digital image data corresponds to the user based on a determination that first image data and the digital image data likely corresponds to a same person, wherein the first image data is obtained by:
generating and sending, to the user computing device by a secure communication link, display instructions configured to, when executed, display a user interface that comprises a live camera view to capture first image data of the user using a camera corresponding to the user computing device, and
receiving, from the user computing device by the secure communication link, a data packet comprising the first image data;
generate, by the PIN generation processor, an alphanumeric personal identifier;
generate, by the credit file generation processor, a credit file for the user associated with the alphanumeric personal identifier;
identify, by the credit file generation processor, a new tradeline from a set of transactions within transaction data that collectively relate to a tradeline category; and
generate, by the credit file generation processor, an updated credit file for the user comprising the new tradeline that corresponds to the tradeline category.

22. The system of claim 21, wherein to determine that the digital image data corresponds to the user, the instructions, when executed by the one or more hardware processors, cause the one or more hardware processors to:
input, into a machine learning model, input data comprising the first image data and at least a portion of the digital image data; and
receive, from the machine learning model, an output that indicates a likelihood that the first image data and the digital image data correspond to a same person.

23. The system of claim 22, wherein the machine learning model is trained by:
obtaining a training dataset comprising a plurality of data pairs, wherein each data pair comprises (i) first image data corresponding to a government issued ID that includes a first photographic depiction of a face of a person, and (ii) second image data corresponding to a face of the person, wherein the second image data originates from a source other than the government issued ID, wherein each data pair corresponds to a different person; and
training, using the training dataset, the machine learning model to determine that third image data corresponding to a government issued ID that includes a second photographic depiction of a first face and fourth image data of a second face depict a same person.

24. The system of claim 21, to identify the new tradeline, the instructions, when executed by the one or more hardware processors, cause the one or more hardware processors to:
receive credentials from the user for directly accessing, by proxy on behalf of the user via an Application Programming Interface (API), transaction data associated with the user stored in one or more databases of a third-party entity; and
transmit at least an API token associated with the third-party entity and the credentials to the one or more databases of the third-party entity.

25. The system of claim 21, wherein the instructions, when executed by the one or more hardware processors, further cause the one or more hardware processors to generate a credit score of the user based on the updated credit file.

26. The system of claim 21, wherein the instructions, when executed by the one or more hardware processors, further cause the one or more hardware processors to determine that the user is not eligible for a credit score based on a scoring algorithm.

27. The system of claim 26, wherein the new tradeline is a first tradeline, wherein the tradeline category is a first tradeline category, and wherein the instructions, when executed by the one or more hardware processors, further cause the one or more hardware processors to:
in response to determining that the user is not eligible for a credit score, identify, by the credit file generation processor, a second tradeline from a set of transactions within transaction data that collectively relate to a second tradeline category;
generate, by the credit file generation processor, a second updated credit file for the user comprising the second tradeline; and
in response to generating a second updated credit file for the user, determining that the user is eligible for a credit score.

28. The system of claim 27, the instructions, when executed by the one or more hardware processors, further cause the one or more hardware processors to generate a credit score of the user based on the second updated credit file.

29. The system of claim 21, wherein the transaction data includes transactions between a user and one or more payees, and wherein the instructions, when executed by the one or more hardware processors, further cause the one or more hardware processors to:
access the transaction data from one or more databases associated with one or more third-party entities storing the transaction data; and
standardize payee data for at least one payee, wherein standardizing the payee data for the at least one payee comprises associating a standardized identifier for the at least one payee with one or more adaptations of payee information for the at least one payee.

30. The system of claim 21, wherein the identification information associated with the digital image data comprises a name and an address of an individual associated with the government issued ID.

31. The system of claim 21, wherein the instructions, when executed by the one or more hardware processors, further cause the one or more hardware processors to:
transmit the alphanumeric personal identifier to a third-party entity;
receive a request for the credit file from the third-party entity, wherein the request comprises the alphanumeric personal identifier; and
transmit the credit file to the third-party entity.

32. The system of claim 21, the instructions, when executed by the one or more hardware processors, further cause the one or more hardware processors to recommend one or more data items to the user for which the user was not eligible prior to the generation of the credit file.

33. The system of claim 32, wherein the one or more data items comprise a feature to provide additional information related to improving the credit file.

34. The system of claim 32, wherein the one or more data items comprise a feature to monitor the credit file.

35. The system of claim 21, wherein the instructions, when executed by the one or more hardware processors, further cause the one or more hardware processors to provide the alphanumeric personal identifier to a third party for identity verification of the user by the third party.

36. The system of claim 21, wherein the instructions, when executed by the one or more hardware processors, further cause the one or more hardware processors to verify that the name and a social security number provided by the user via the user computing device matches a name and social security number in a government database.

37. A method comprising:
receiving, from a user computing device, Personal Identifiable Information (“PII”) and digital image data comprising a government issued identification document (“ID”), wherein the PII includes a name and an address of a user associated with the user computing device;
determining, by a credit file generation processor, that identification information associated with the digital image data corresponds to the PII;
comparing, by a credit file generation processor, the PII with credit files in a credit file database to determine that there is no match;
determining, by a credit file generation processor, that the digital image data corresponds to the user based on a determination that first image data and the digital image data likely corresponds to a same person, wherein the first image data is obtained by:
generating and sending, to the user computing device by a secure communication link, display instructions configured to, when executed, display a user interface that comprises a live camera view to capture first image data of the user using a camera corresponding to the user computing device, and
receiving, from the user computing device by the secure communication link, a data packet comprising the first image data;
generating, by a PIN generation processor, an alphanumeric personal
generating, by the credit file generation processor, a credit file for the user associated with the alphanumeric personal identifier;
identifying, by the credit file generation processor, a new tradeline from a set of transactions within transaction data that collectively relate to a tradeline category; and
generating, by the credit file generation processor, an updated credit file for the user comprising the new tradeline that corresponds to the tradeline category.

38. The method of claim 37, wherein determining that the digital image data corresponds to the user comprises:
inputting, into a machine learning model, input data comprising the first image data and at least a portion of the digital image data; and
receiving, from the machine learning model, an output that indicates a likelihood that the first image data and the digital image data correspond to a same person.

39. The method of claim 38, wherein the machine learning model is trained by:
obtaining a training dataset comprising a plurality of data pairs, wherein each data pair comprises (i) first image data corresponding to a government issued ID that includes a first photographic depiction of a face of a person, and (ii) second image data corresponding to a face of the person, wherein the second image data originates from a source other than the government issued ID, wherein each data pair corresponds to a different person; and
training, using the training dataset, the machine learning model to determine that third image data corresponding to a government issued ID that includes a second photographic depiction of a first face and fourth image data of a second face depict a same person.

40. A non-transitory computer storage medium storing instructions that, when executed by one or more processors comprising a credit file generation processor and a PIN generation processor, cause the one or more processors to:
receive or access, from a user computing device, Personal Identifiable Information (“PII”) and digital image data comprising a government issued identification document (“ID”), wherein the PII includes a name and an address of a user associated with the user computing device;
determine, by the credit file generation processor, that identification information associated with the digital image data corresponds to the PII;
compare, by the credit file generation processor, the PII with credit files in a credit file database to determine that there is no match;
determine, by the credit file generation processor, that the digital image data corresponds to the user based on a determination that first image data and the digital image data likely corresponds to a same person, wherein the first image data is obtained by:
generating and sending, to the user computing device by a secure communication link, display instructions configured to, when executed, display a user interface that comprises a live camera view to capture first image data of the user using a camera corresponding to the user computing device, and
receiving, from the user computing device by the secure communication link, a data packet comprising the first image data;
generate, by the PIN generation processor, an alphanumeric personal identifier;
generate, by the credit file generation processor, a credit file for the user associated with the alphanumeric personal identifier;
identify, by the credit file generation processor, a new tradeline from a set of transactions within transaction data that collectively relate to a tradeline category; and
generate, by the credit file generation processor, an updated credit file for the user comprising the new tradeline that corresponds to the tradeline category.
